(19) United States
(12) Patent Application Publication
(10) Pub. No.: US 2008/0223130 A1
(43) Pub. Date: Sep. 18, 2008

(54) Method and device for measuring density of a liquid

(75) Inventors: Gregory Dixon Snell, San Jose, CA (US); Thomas Lorincz, Hollister, CA (US); Mike Ravkin, Sunnyvale, CA (US)

Correspondence Address: PROVINA INCORPORATED;Att. Greg Snell, # 200, 2570 N. First Street, San Jose, CA, 95131, US

(73) Assignee: PROVINA INCORPORATED

(21) Appl. No.: 11/717,213

(22) Filed: Mar. 13, 2007

(51) Int. Cl. G01N 9/30; G01N 9/36

(52) U.S. Cl. 73/450; 73/32 R

(57) ABSTRACT

A sensor for measuring density of a liquid that comprises a float unit having a sealed hollow casing that contains a first magnet and a strain-gauge unit having a sealed hollow casing that contains a strain gauge and a second magnet arranged coaxially to the first magnet. Coaxiality of the magnets is provided by means of a guide rod installed on the casing of the strain-gauge unit and used to guide the float unit by inserting the guide rod into the central opening of the float unit casing. A characteristic feature of the sensor is that changes in the density of the liquid that cause displacement of the float cause detectable deformations of the strain gauge via forces of magnetic interaction between the first and second magnets without physical contact between the magnets. Since the elements of the sensor are located in sealed casings, they are not subject to damage and do not require maintenance.

### FIELD OF THE INVENTION

The present invention relates to a device for measuring density of a liquid. More specifically, the invention concerns a device and method for measuring the content of a substance that changes the density of a liquid, e.g., the content of sugar in a grape must during fermentation in a winemaking process. In particular, the aforementioned device and method may find application in conjunction with a wine press that is equipped with means for controlling temperature and sugar content of the must in a winemaking process.

### BACKGROUND OF THE INVENTION

Although the subsequent description relates mostly to the content of sugar in a wine, it should be understood that reference to the wine is given only as an example and that the same principle applies to measuring the content of any other substance that is contained in a liquid, the density of which depends on the content of the aforementioned substance.

Winemaking is a very old and complex process. For about 5,000 years man has used grapes to make wines by fermentation. In fact, wine can be defined as a liquid obtained as a result of partial or complete fermentation of the juice of grapes, other fruits, or berries. However, grape is the only fruit with a sufficiently high level of natural sugar and with the proper balance of acid and nutrients to sustain natural fermentation to dryness with stable results. Fermentation of other fruits and berries may require addition of sugar, acid, or various yeast nutrients to avoid spoiling.

Although there have been improvements in various aspects of the winemaking process over the years, these improvements have been primarily in the equipment used in the processing of the grapes. The basic reaction by which grapes are transformed into wine remains unchanged. Typically, grapes are crushed to release the juice into a fermentation vessel. When the fermentation is complete, the wine is pressed to separate the liquid from the stems, skin, pips, and pulp. Wine is then stored to age and clarify.

Ripe grapes naturally have yeast cells residing on their surface that aid and abet the reaction of grapes into wine. When the yeast comes into contact with grape juice, the yeast begins to feed on the juice. The yeast contains the enzyme, zymase, which converts sugar in the grape juice to alcohol and carbon dioxide and which releases heat. The reaction continues naturally until the sugar has been converted or the yeast dies off or weakens.

Fermentation usually takes about three weeks. During the first few days of the process, which is frequently referred to as “aerobic fermentation,” the reaction usually produces more yeast through reproduction of the yeast cells. This first step is followed by anaerobic fermentation which produces the most alcohol. Fermentation may be permitted to continue until there is no residual sugar, or the reaction may be terminated at some point during the process to vary the level of sweetness. The reaction is usually terminated by killing or removing the yeast cells. This may be accomplished by adding alcohol to raise the level to 15% or more, adding sulfur dioxide or sorbate (sorbic acid), by filtering through a sterile filter, or by chilling the must and filtering out the yeast cells.

The color of the wine comes from contact of the grape juice, which is clear, with the skin of the grapes. The greater the color of the skin, plus the amount of time the juice is in contact with the skin, increases the color of the wine. Different steps in winemaking can cause variations in taste and bouquet; for example, juice separated from the must before pressing usually has less bitterness and oxidation. The speed and pressure of the press may also affect the wine. Too much pressure in the press may cause bitter tannins to leach from the seeds.

There is also a second fermentation that occurs in most winemaking. This is called malolactic fermentation. In this type of fermentation, bacteria, i.e., lactobacillus, converts some of the malic acid naturally present in grapes into lactic acid along with the resultant byproduct of carbon dioxide. Malolactic fermentation usually has the effect of softening the wine, i.e., taking some of the edge off the wine.

Acids are a natural component of wine. However, if a wine is too low in acid, the wine tastes too flat and dull. If the wine has too great an amount of acid, the wine tastes too tart and sour. As a result, the winemaker frequently manipulates acidity in wine. The principal acids formed in grapes and therefore in wine are tartaric acid, potassium hydrogen tartrate, and malic acid and potassium hydrogen malate. The relative amounts of acid depend on the grape variety used to make the wine. In addition, the growing temperature of the grapes can also affect the amount of acidity in a wine. There are other factors that may affect the taste of wine, such as climate of the area in which the grape grows, barrels used for cellaring, exposure to UV light, etc.

Among all factors listed above, the content of sugar is the main factor that affects the taste of wine and that is used as a criterion for controlling the degree of readiness of the wine as a result of fermentation.

In the United States the so-called Brix scale measures the sugar content of grapes and wine. The term “Brix” stems from the name of a nineteenth-century German inventor. Normally, Brix (sugar content) is determined by a hydrometer.

The hydrometer is a simple instrument that measures the weight, or gravity, of a liquid in relation to the weight of water. Because the relation of the gravity to water is specified, the resulting measure is called a specific gravity. A hydrometer floats higher in a heavy liquid, such as one with a quantity of sugar dissolved in it, and lower in a light liquid, such as water or alcohol. In truth, the average winemaker has no interest in the specific gravity of a must, per se, but has a very keen interest in the amount of sugar dissolved in it because yeast converts sugar into carbon dioxide and alcohol. By knowing how much sugar one starts with and ends with, one can easily calculate the resulting amount of alcohol.

There are many types of hydrometers. Some have only one scale, some two, and some three. The typical hydrometer measures three things: specific gravity (SG), potential alcohol (PA), and sugar.

The specific gravity scale usually reads from 0.990 to 1.120. The SG of water is 1.000. If one fills a test jar (a deep chimney-shaped vessel that holds from one half to two cups of juice) with water and floats a hydrometer in it, the water surface should rest at the 1.000 mark. As sugar dissolves in water, the hydrometer floats to a higher level. One pound of sugar dissolved in one US gallon (3.7853 liters) of water floats a hydrometer to the level of 1.045. (Please note that one pound of sugar dissolved in one gallon of water is not the same as one pound of sugar added to one gallon of water. In the first instance, there is one gallon of liquid. In the second instance, there is one gallon and ten fluid ounces of liquid.)

Table wines are generally started at an SG of 1.090 or higher and are fermented to dryness, i.e., 0.990 to 1.000. Sweeter wines are started at a higher SG and are stabilized at the desired sweetness, or, more commonly, started at 1.090 or higher, fermented to dryness, stabilized, and sugar added back to the wine to sweeten it.

Sugar can be measured in ounces per gallon or in degrees Balling, or Brix. Ounces per gallon are measured on a numeric scale in which an SG of 1.045 equals 16 oz. (one pound) sugar per U.S. gallon. Brix is measured as a percentage of sugar by which pure water has a Brix of 0 (or 0% sugar), an SG of 1.045 equals a Brix of 11.7 (11.7% sugar), and an SG of 1.095 equals a Brix of 23.1 (23.1% sugar).

The potential alcohol scale typically reads from 0 to 16%. Using the standard hydrometer, one cannot measure the alcohol in a finished wine. But one can measure the PA before the yeast is added and again after fermentation is complete. By simple subtraction, the PA lost is the percentage of alcohol in the finished wine.

Other methods and devices are available for measuring sugar content in a liquid, e.g., in wine. One such method is the use of floats immersed into the liquid and then changing the position of the float in the liquid in response to the change in liquid density.

U.S. Pat. No. 6,026,683 issued in 2000 to Buyong Lee describes a liquid-level measuring system using a strain-gauge load cell. The system includes a buoyancy weight standing upright in liquid held in an object to be measured in a long bar shape, and having an average density substantially the same as that of the liquid; the strain-gauge load cell producing the change in the buoyancy weight varies with the liquid level when there is a change in an electrical signal; an amplifier amplifying a voltage signal detected from the strain-gauge load cell; an analog/digital converter converting an amplified voltage signal into a digital signal; a central processing unit applying a driving pulse to the strain-gauge load cell and average-operating a plurality of digital signals to find an average value of the liquid level; and a display displaying the average value of the liquid level as a number. A disadvantage of this device is the limited area of use since it is intended for a specific application. The measurement element, i.e., the rod that connects the float with the strain gauge and the strain gauge, itself, is exposed to the liquid to be controlled or to its vapors. Therefore the device is difficult to maintain.

UK 1,165,451 Patent published in 1969 to W. Becker, et al., discloses a float for the accurate measurement of a liquid level that is provided with a temperature-responsive element, such as an expansion body, which moves an inductor disk vertically to compensate for deeper immersion of the float in the liquid due to a decrease in liquid density with a rise in temperature. The temperature-responsive element may be bimetallic strips used in conjunction with a sleeve of magnetic material within the float, or the element may be a fluid expanding a bellows supporting a cylinder with the float.

Russian Patent No. 2193181 issued in 2002 to M. Kagan describes a device for measuring density of a liquid, in particular for continuous density measurement of petroleum products directly in storage tanks. The principle of the invention consists of converting movements of a float into an electric signal. A signal converter comprises an autogenerator of RF oscillations. One of the oscillation circuits is a coaxial line vertically submerged into the liquid being controlled, along with a surrounding float that supports an external, annular permanent magnet. This magnet interacts with another magnet that is located inside the coaxial line. When density of the liquid changes, the outer magnet moves in the appropriate direction due to change in buoyancy and causes movement of the inner magnet. The latter is connected to a short-circuiting plunger made from a non-magnetic material and having sliding galvanic contact with both tubes of the coaxial line. When the plunger moves, it changes the active length of the coaxial line and thus changes the frequency of the signal generated by the signal generator in response to the density of the liquid. The device of this invention is complicated in structure and is difficult to maintain.

European Patent EP 0073158 published in 1983 (inventors R. Guay, et al.) describes an electronic hydrometer for determining the density of a liquid. The hydrometer comprises a housing having a liquid-receiving chamber and means to insert a liquid, the density of which is determined in the chamber. A float having a known weight is disposed in the chamber. A connecting shaft is secured to the float and is retained for guided displacement along its longitudinal axis in response to introduction of a predetermined quantity of liquid in the chamber. A sensor is associated with a shaft for detecting a reference position of the shaft. A permanent magnet is mounted near the shaft and has a magnetic core and a displacement coil surrounding the core. The coil is secured to the shaft. An electronic circuit means automatically adjusts the valve of the current flowing in the coil to displace the coil and the shaft relative to the reference position. The circuit calibrates the value of the adjusted current in order to generate an output signal that indicates the density of the liquid in the chamber.

Thus, the common disadvantage of the known sensors of a float-and-strain-gauge type is their complicated construction or inconvenient maintenance.

### SUMMARY

It is an object of the invention to provide a sensor for measuring density, which is simple in construction, inexpensive to manufacture, reliable in operation, highly sensitive, and easy to maintain. Another object is to provide the aforementioned sensor in which a force proportional to change in density of the liquid is transmitted to the strain gauge in a manner that requires no contact. Another object is to provide a sensor of the aforementioned type for measuring the content of sugar in a winemaking must where the force is magnetically transmitted from the float to the strain gauge. Another object is to provide a method for measuring the density of a liquid by means of a sensor with magnetic interaction between a magnet installed in a float and a magnet installed in a strain-gauge unit.

The liquid-density control sensor of the invention (hereinafter referred to as a sensor) consists of two main units, i.e., a float unit and a strain-gauge unit. Both aforementioned units are independently sealed, spaced apart from each other, and magnetically interactive via magnets installed in both units. The entire sensor, i.e., the float unit and the strain-gauge unit, are completely submerged into a liquid, the density of which is to be controlled. More specifically, the strain-gauge unit consists of a strain-gauge holder that is made in the form of an elongated strip or a bar of a substantially flexible material that supports the strain gauge cemented to its surface and a first permanent magnet of certain polarity. The strip or bar that carries the strain gauge and magnet is placed into a sealed casing, and the strip or bar is—in a cantilevered manner—attached to a stationary object, e.g., a wall of the aforementioned box. The vertical position of the sealed casing may be adjusted by moving it along the guides provided on the inner wall of the container. The lead wires of the strain gauge are guided to the outside of the container in a sealed manner, e.g, via feedthrough devices, and are further guided to a measurement instrument, e.g., a potentiometer or a Wheatstone bridge, or a similar device for accurate measurement of changes in electrical resistance. The upper surface of the casing supports a vertically arranged guide rod which is coaxial with the position of the first magnet. This guide rod slidingly supports the aforementioned float unit that consists of a sealed hollow body provided with a through-central opening into which the guide rod is inserted without violation of the hermetic conditions inside the sealed body of the float. Attached to the bottom of the hollow, sealed float body is a second permanent magnet with a polarity that provides magnetic interaction with the first permanent magnet.

The forces acting on the components of the sensor are the following. In addition to hydrostatic pressure that uniformly and from all directions acts on the float surfaces, the float unit immersed into the liquid experiences its own gravity force. A force that acts on the float immersed into the liquid is a well known Archimedean force that is equal to the weight of the liquid displaced by the float. It is understood that when the Archimedean force is equal to the weight of the float, the latter is maintained in a freely floating state, i.e., in the so-called weightless condition in the liquid.

Let us assume that under a predetermined density of the liquid, a given float is maintained in a weightless condition in the liquid. If the float is rigidly connected to a strain gauge, then under the aforementioned weightless condition of the float, the strain gauge does not detect any force. However, if density of the liquid increases, the float experiences a positive buoyancy that tends to raise the float to a higher level. In this case, the strain gauge will detect a force that is proportional to the variation in the liquid density. Similarly, if the density of the liquid decreases, the float experiences negative buoyancy that tends to move the float to a lower level. In this case as well, the strain gauge will detect a negative force that is proportional to the variation in the liquid density. If the float is designed with initial negative buoyancy, this negative buoyancy can be compensated through a certain coupling between the float and the gauge. In the present invention, in the case of negative buoyancy of the float, such a coupling is realized in the form of a repelling force between two magnets, one of which is connected to the float unit and another to the strain-gauge unit. If the float is designed with initial positive buoyancy, this positive buoyancy can be compensated through the use of attractive forces between the magnets. Since the force of interaction between the magnets to a great extent depends on the distance between the magnets, even slight changes in the position of the float will create well measurable deformation in the strain gauge. It is understood that changes in the liquid density will change buoyancy of the float and thus cause deformations on the strain gauge.

Provision of the vertical guide rod on which the float slides in the vertical direction restricts the float from movements in the transverse direction. This makes it possible to improve accuracy of measurement since the interactive forces between the magnets strongly depend on the degree of their coaxiality.

Since fermentation is accompanied by formation and accumulation of gas bubbles (CO₂) on the surface of the float, which is undesirable, it is recommended that the surface of the float be spherical for surface minimization. Another factor is minimal roughness of the float surface. Furthermore, the surface of the float should be sufficiently large in order to exclude the effect of the bubbles on the buoyancy of the float.

### BRIEF DESCRIPTION OF THE DRAWINGS

FIG. 1 is a vertical sectional view of the device according to one embodiment of the invention in which the magnets of the float unit and the strain-gauge unit have opposite poles of the same polarities (repelling force between magnets).

FIG. 2 is a diagram of forces acting on the float of the device in FIG. 1.

FIG. 3 is a vertical, sectional view of the device according to another embodiment of the invention in which the magnets of the float unit and the strain-gauge unit have opposite poles of different polarities (attracting force between magnets).

FIG. 4 is a diagram of forces acting on the float of the device in FIG. 3.

FIG. 5 is an embodiment of the invention with the position of the sensor adjustable in the vertical direction relative to the level of the liquid in the container.

FIG. 6 is a side sectional view of the device according to the embodiment of the invention where the strain gauge casing is arranged above the level of the liquid.

FIG. 7 a side sectional view of the device according to the embodiment of the invention where the guide means for the floating unit is made in the form of a tubular body into which the floating unit is inserted with a sliding fit.

FIG. 8 is a sectional view of a device according to another embodiment of the invention, wherein means for maintaining the first magnet and the second magnet in coaxial alignment comprise flexible elements that support the floating unit in a spaced position above the strain gauge unit in a bridge-like manner.

FIG. 9 is an example of a graph that was obtained for a magnetically coupled sensor of the invention and that shows dependence of an electrical signal that corresponds to the density of the liquid (in mV units) from the content of sugar in the wine must (in Brix scale units).

### DETAILED DESCRIPTION OF THE INVENTION

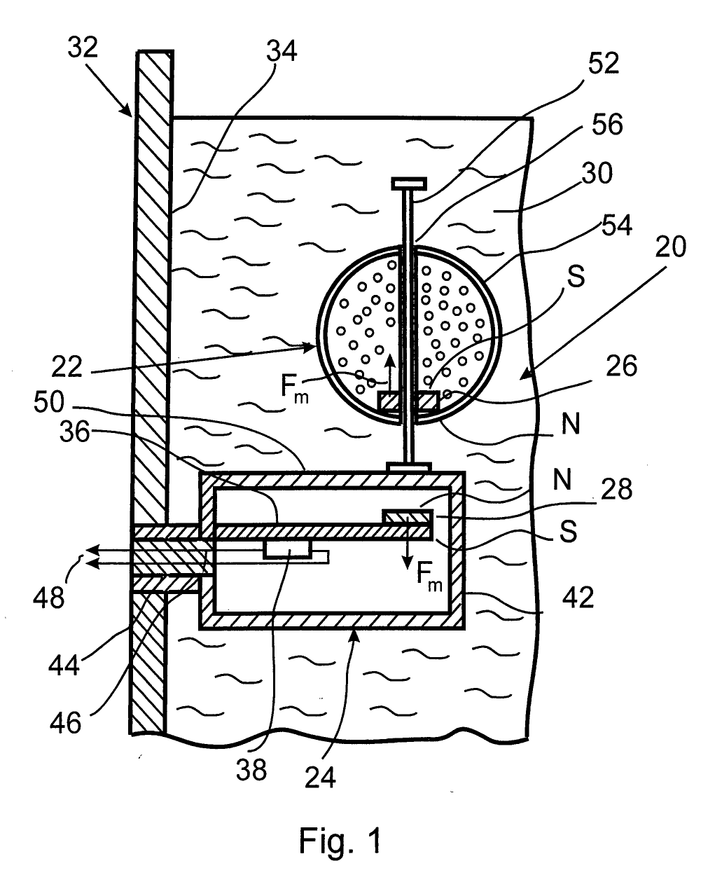

A sectional schematic view of the device of the invention is shown in FIG. 1. It can be seen that a liquid-density control sensor 20 of the invention (hereinafter referred to as a sensor) consists of two main units, i.e., a float unit 22 and a strain-gauge unit 24. Both aforementioned units 22 and 24 are independently sealed, spaced apart from each other, and magnetically interactive via magnets 26 and 28 rigidly installed in both units, respectively.

The entire sensor 20, i.e., the float unit 22 and the strain-gauge unit 24, are completely submerged into a liquid 30, the density of which is to be controlled. The liquid 30 is held in a container 32, only a wall 34 of which is shown in FIG. 1. The liquid 30 may comprise any liquid medium, the density of which may change. For example, this may be a salt solution, the density of which changes depending on the concentration of salt; or it may be a wine must, the concentration of which may vary depending on the percentage of sugar. For the sake of example only, let us consider the case of a wine must, the density of which changes in the course of fermentation during the winemaking process.

More specifically, the strain-gauge unit consists of a strain-gauge holder 36 that is made in the form of an elongated strip or a bar of a substantially resilient non-conductive and non-magnetic material that supports a strain gauge 38 cemented to the surface of the holder.

The holder 36 also supports a first permanent magnet 28 of certain polarity. Preferably, the magnet should have a symmetrical shape, e.g., round or square, and should have one of the magnetic poles on the surface of the holder and the opposite magnetic pole on the surface perpendicular to the first pole. A preferable type of the magnet 28 suitable for the invention is a magnetic rod or a disk with opposite poles on opposite end faces of the rod or the disk.

The holder 36 that carries the strain gauge 38 and the aforementioned magnet 28 is placed into a sealed casing 42, and the holder 36 is attached in a cantilevered manner to a stationary object, e.g., a wall of the aforementioned casing 42. In the embodiment shown in FIG. 1, the casing 42 is rigidly attached to the wall 34 of the container 32 by means of a connection device 44 with a feedthrough device 46 for guiding lead wires 48 to the measurement unit (not shown in FIG. 1), such as a potentiometer or a Winston bridge, or a similar device for accurate measurement and registration of changes in electrical resistance.

The upper surface 50 of the casing 42 supports a vertically arranged guide rod 52, which is coaxial with the position of the first magnet 28. This guide rod 52 slidingly guides the aforementioned float unit 22 that consists of a sealed hollow body 54 provided with a through-central opening 56 into which the guide rod 52 is inserted without violation of the hermetic conditions inside the sealed body 54. Attached to the bottom of the hollow, sealed float body 54 is the aforementioned second permanent magnet 26 with a polarity that provides magnetic interaction with the first permanent magnet 28. In order to adjust the weight of the float unit 22 and to fix the second magnet 26 inside the float body 54, the latter may be filled with a light material such as foam plastic 23.

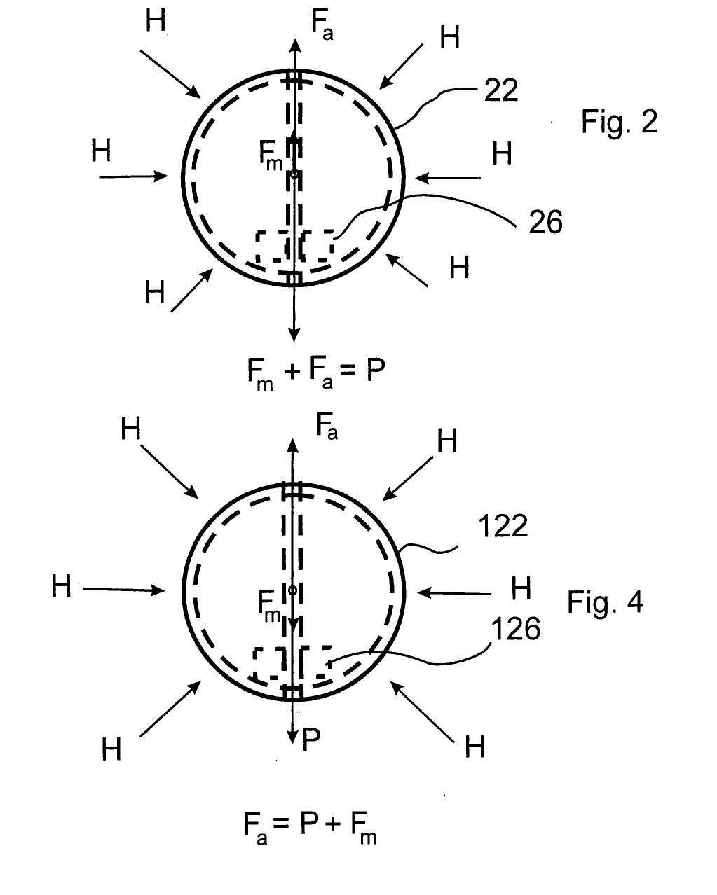

The forces acting on the components of the sensor 20 are shown in FIGS. 1 and 2, where FIG. 2 is a view that for convenience of explanation shows only the float unit 22. The forces acting on the float unit 22 shown in FIGS. 1 and 2 relate to the case of negative buoyancy of the float 22.

In addition to the hydrostatic pressure shown in FIG. 2 by arrows H that acts uniformly from all directions on the float surfaces, the float unit 22 immersed into the liquid 30 experiences its own gravity force P. Another force that acts on the float unit 22 immersed into the liquid 30 is the well known Archimedean force F_{A} that is equal to the weight of the liquid displaced by the float unit 22. It is understood that when the Archimedean force F_{A} is equal to the weight of the float, the latter is maintained in a freely floating state, i.e., in the so-called weightless condition in the liquid.

Let us assume that under a predetermined density of the liquid 30, a given float unit 22 is maintained in a weightless condition in the liquid. If the float unit 22 were rigidly connected to the holder 36 of the strain gauge 38, then under the aforementioned weightless condition of the float unit 22, the strain gauge 38 would not detect any force. If, in this case, density of the liquid increases, the float unit 22 experiences positive buoyancy that tends to raise the float to a higher level. The strain gauge 38 then detects a force that is proportional to the increase in the liquid density. Similarly, if the density of the liquid 30 were decreased, the float would experience negative buoyancy that tends to move the float to a lower level. In this case as well, the strain gauge 38 detects a force that is proportional to the decrease in the liquid density. If the float is designed with certain initial negative buoyancy, this negative buoyancy is compensated through a certain coupling between the float unit 22 and the strain gauge 38.

In contrast to the above condition with a mechanical kinematic link between the float unit and the strain-gauge holder, in the case of the present invention and, in particular, of the embodiment shown in FIG. 1 with negative buoyancy of the float unit 22, the aforementioned link between the float unit 22 and the strain-gauge holder 36 is realized in the form of a repelling force F_{M} (FIG. 2) between two magnets 26 and 28 (FIG. 1), one of which (26) is connected to the float unit 22 and another (28) to the holder 36 in the strain-gauge unit 24.

In the case of negative buoyancy and arrangement of the magnets 26 and 28 in the manner shown in FIG. 1, the float unit 22 assumes a position on the guide rod 52 that is determined by the following balance of forces: F_{A}+F_{M}=P.

Since the interaction between the magnets 26 and 28 to a great extent depends on the distance between them, even slight changes in the position of the float 22 will create well measurable deformation in the strain gauge 38. It is understood that changes in the density of the liquid 30 will change buoyancy of the float unit 22 and thus cause deformations on the strain gauge 38.

Provision of the vertical guide rod on which the float slides in the vertical direction restricts the float from movements in the transverse direction. This makes it possible to improve accuracy of measurement since the interactive forces between the magnets strongly depend on the degree of their coaxiality.

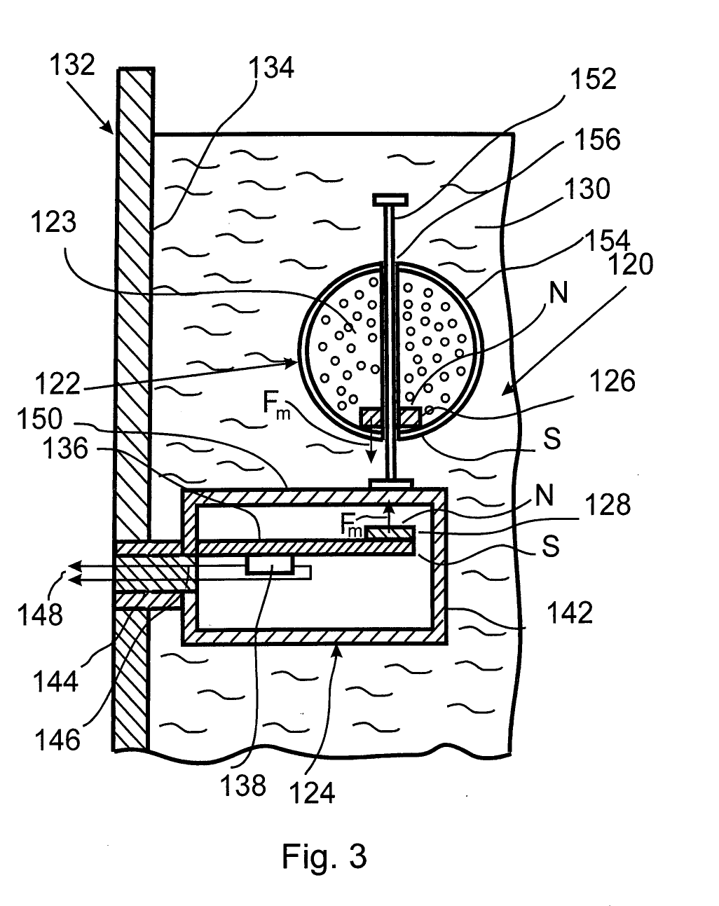

FIG. 3 illustrates another embodiment of the device of the invention that is substantially the same as the embodiment of FIG. 1, except that the poles of the magnets generate a force of mutual attraction instead of a repellant force. Since the majority of the parts of a sensor 120 shown in FIG. 3 is identical to those shown in FIG. 2, they will be designated by the same reference numerals with an addition of 100, and their detailed description will be omitted. FIG. 4 is similar to FIG. 2, except that force F_{M} has a direction opposite to one shown in FIG. 2. In accordance with this embodiment, the permanent magnets 126 and 128 have magnetic poles of opposite signs whereby the following balance of forces can be written, as shown in FIG. 4: F_{A}=P+F_{M}, where F_{A}, P, and F_{M} have the same meanings as defined above. It is understood that when density of the liquid decreases and causes the float unit 122 to move toward the strain-gauge unit 124, the distance between the magnets will be reduced. However, this will increase the force attraction between the magnets and at a predetermined position of the float will violate the condition of balance of forces acting on the float unit 122. In other words, the force of mutual attraction will tend to bring the magnets 126 and 128 into mutual physical contact. Nevertheless, the sensor of FIG. 3 will work in a predetermined range of forces F_{A}, P, and F_{M}, the misbalance of which can be prevented by a stopper 129 formed on the guide rod 152. This stopper 129 is located on the rod 152 in a position that provides substantial balance between the force to satisfy the equation F_{A}=P+F_{M} (FIG. 4). Since the sensor 120 of the embodiment of FIG. 3 can operate under limited conditions, use of the embodiment in FIG. 2 is preferable.

The lead wires of the strain gauge are guided to the outside of the container 132 in a sealed manner, e.g, via a connector 144 with a feedthrough device 146.

In the case of both embodiments, the lead wires are guided further to a measurement instrument (not shown), e.g., a potentiometer or a Wheatstone bridge, or a similar device for accurate measurement of changes in electrical resistance. The obtained analog signal is converted into a digital form and is either registered in a computer, CPU, or the like, or is used for controlling the process through a feedback line (not shown). The measurement system is conventional and is beyond the scope of the present invention.

Since some technological processes may be accompanied by variations in temperature, which, in turn, may affect the data detected by the sensor, the aforementioned data can be corrected to compensate deviations caused by variations in temperature of the liquid. A good example of such a process is fermentation of a must in the production of wine. In this process, the temperature of the must varies in the range of 10° C. to 35° C. During fermentation, the must density changes in the range of 1.10 to 0.99 or about 10%. Therefore, in order to provide optimal operation of the sensor in the aforementioned density change range, the following calibration procedure is carried out. A liquid is selected, the density of which is known at a predetermined temperature. Following this, the temperature of the liquid is changed at a certain temperature interval, e.g., 2° C., and the density is measured for each temperature within the expected temperature change interval. This procedure is repeated for the entire density change interval. As a result, certain data are accumulated and are stored in a memory device of the measurement system. Since in the controlled process the temperature of the liquid is measured independently, e.g., by a thermocouple located in the liquid, the density measurement data can be corrected.

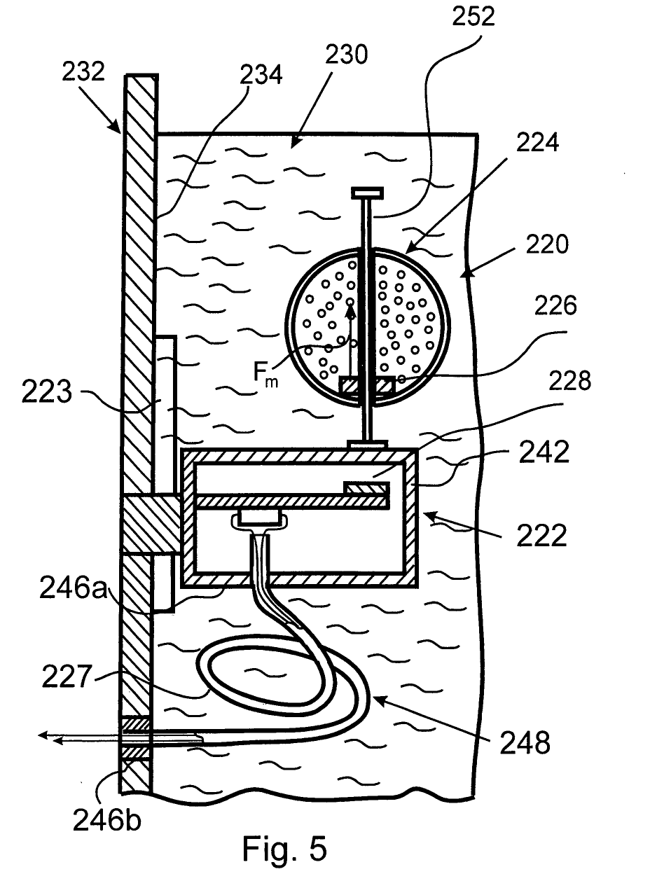

FIG. 5 illustrates another embodiment of the sensor 220 of the invention, according to which the entire sensor unit 222 can be shifted in the vertical direction on a guide 223 formed on the wall 234 relative to the level L of the liquid 230 in the container 232. Positions of the sensor 220 on the guide 223 can be fixed by a screw 225. The lead wires 248 are guided from the casing 242 to the outside of the container 232 first via a feedthrough 246a to the container 232 and then via a feedthrough 246b to the outside of the container 232 to the measurement instrument. The portion 227 of the lead wires 248 that is located in the liquid 230 is isolated by a sealed coating and is wound into a loop in order to compensate for displacements of the sensor unit 222. Reference numeral 252 designates a guide rod; 226 is a magnet of the float unit, and 228 is a magnet of a strain gauge unit.

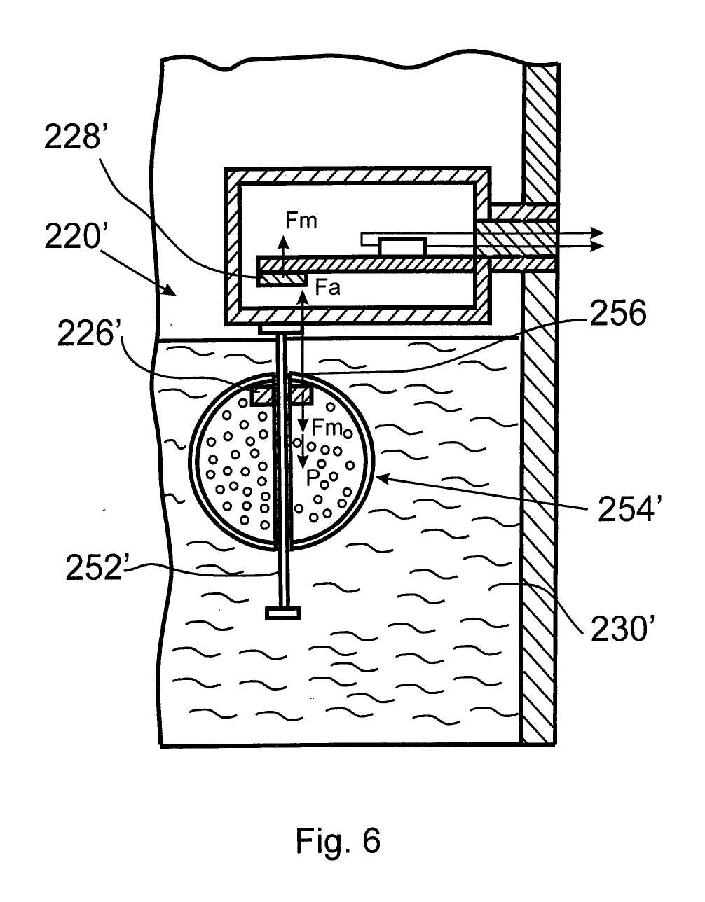

FIG. 6 illustrates another embodiment of the invention wherein the parts similar to those of the embodiment of FIG. 1 are designated by the same reference numerals with an addition of 200 and a prime sign. For example, in the embodiment of FIG. 6 the strain gauge unit 24 of FIG. 1 will be designated by reference numeral 224′. The float unit 22 of FIG. 1 will be designate in FIG. 6 by reference numeral 222′, etc. In general, the embodiment of FIG. 6 is similar to the embodiment of FIG. 3 and differs from it in that the strain gauge unit 224′ is arranged above the level of the liquid 230′ and that the guide means, i.e., the guide rod 252′, is attached to the lower side of the casing 242″ and is directed in the downward direction towards the sealed hollow body 254′ of the float unit. Similar to the embodiment of FIG. 1, the guide rod 252′ passes in a sealed manner through the central opening 256′ of the sealed hollow body 254′, and the magnets 226′ and 228′ face each other with the magnetic poles of the same polarity. The embodiment of FIG. 6 is convenient in that it provides more convenient excess to the strain gauge for its maintenance, replacement, or repair. The hollow casing 242′ need not be sealed as it is not immersed into the liquid.

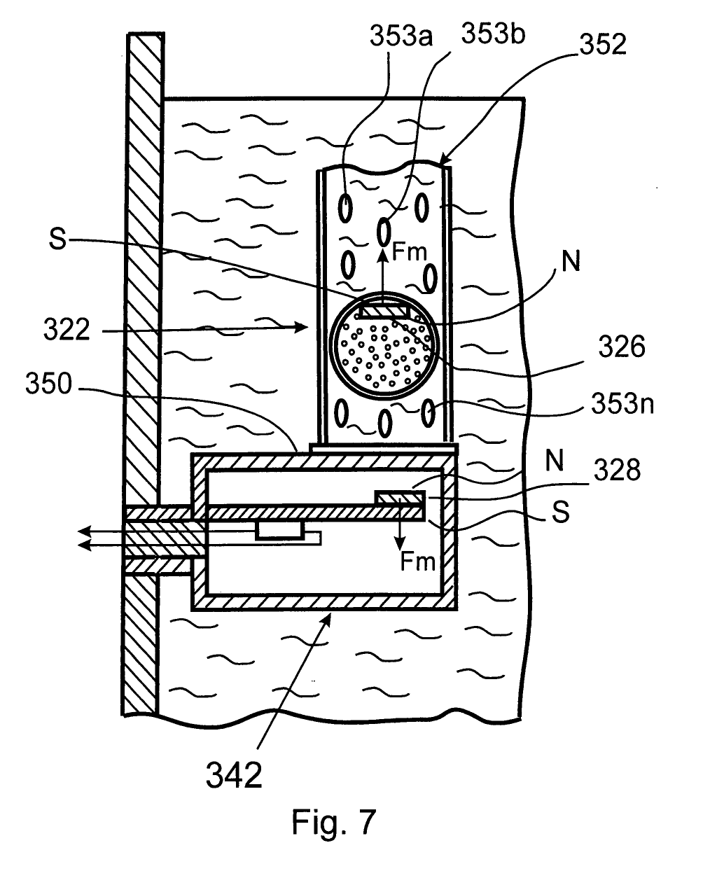

FIG. 7 illustrates another embodiment of the invention, in which the guide means 352 for guiding the magnet 326 of the float unit 322 in alignment with the magnet 328 of the strain gauge unit 324 is made in the form of a tubular body attached to the upper surface 350 of the of the casing 342. The sealed hollow body 354 of the float unit 322 has a spherical shape and is slidingly guided in the tubular guide 352. In order to ensure buoyancy of the spherical floating unit in the guide tube 35 which is immersed into the liquid, the tubular guide 352 has a plurality of perforations 353a, 353b, . . . 353n in its side wall. The rest of the device for measuring density of liquid is the same as in other embodiments.

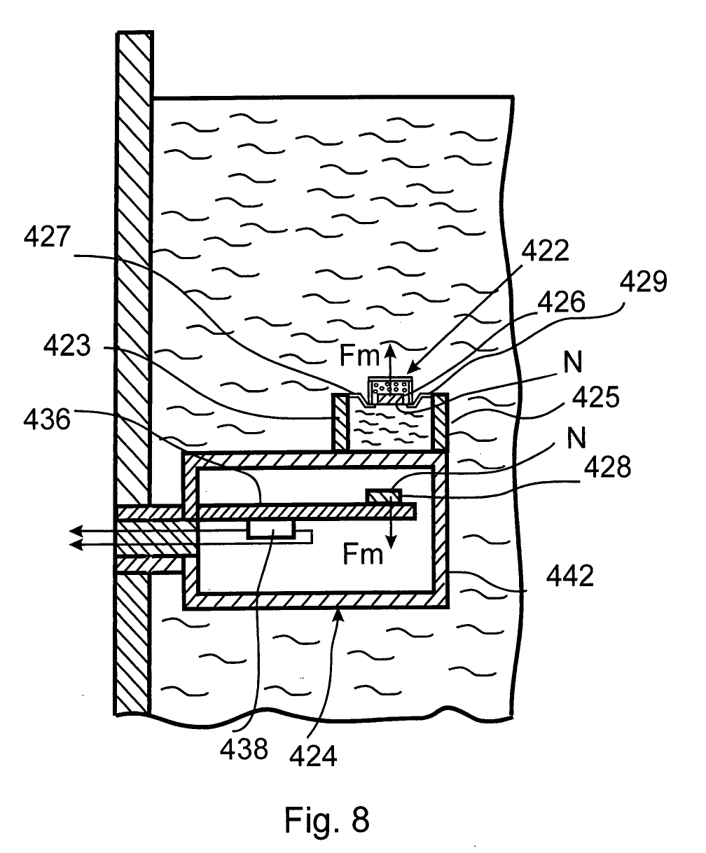

FIG. 8 is a sectional view of a device according to another embodiment of the invention, wherein means for maintaining the first magnet 426 and the second magnet 428 in coaxial alignment comprise flexible elements 427 and 429 that support the floating unit 422 in a spaced position above the strain gauge unit 424. The flexible elements 427 and 429 may comprise, e.g., leaf springs flexibility of which resists the force of magnetic interaction. As can be seen from FIG. 8, the flexible elements have one ends attached to the supports 423 and 425 that project in a vertical directions from the upper surface of the strain gauge casing 424 while other ends of the flexible elements are attached to the opposite sides of the sealed casing of the floating unit 422 so that the floating unit is supported above the strain gauge casing in a bridge-like manner. Depending on whether the magnets face each other with poles of the same or opposite polarity, the flexible elements 427 and 429 should comprise leaf strings of compression or expansion nature.

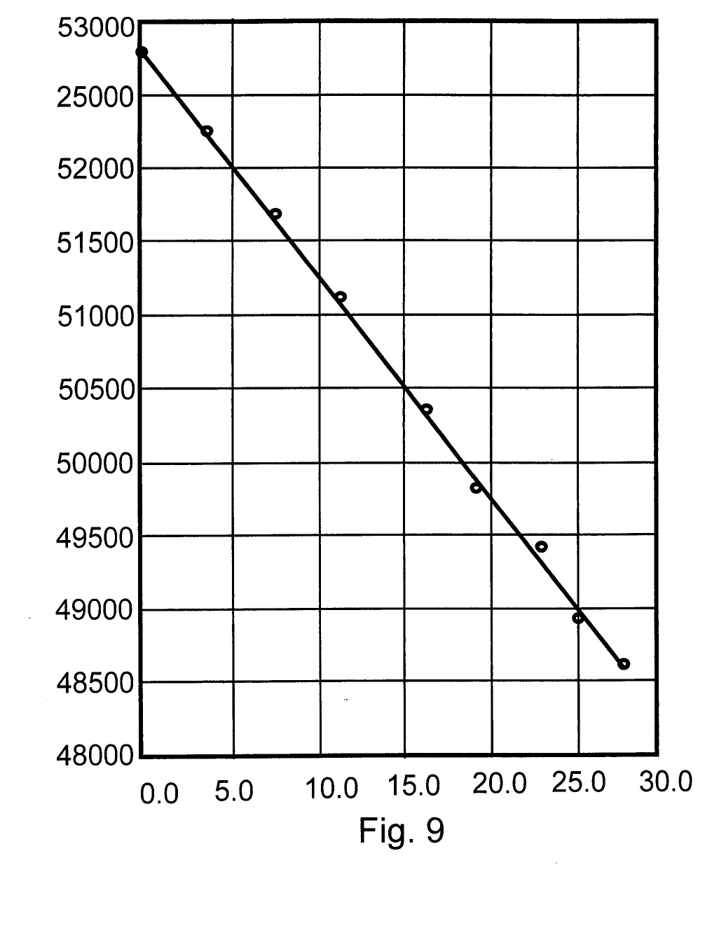

FIG. 9 is an example of a graph that was obtained for a magnetically coupled sensor of the invention and that shows dependence of an electrical signal that corresponds to the density of the liquid (in mV units) from the content of sugar in a wine must (in Brix scale units).

Thus, it has been shown that the invention provides a sensor for measuring density which is simple in construction, inexpensive to manufacture, characterized by improved conditions for maintenance, able to transmit the force proportional to the change in density of the liquid to the strain gauge without contact, reliable in operation, highly sensitive, and suitable for measuring the content of sugar in a winemaking must wherein the force is magnetically transmitted from the float to the strain gauge. The invention also provides a method for measuring density of a liquid by means of a sensor with magnetic interaction between a magnet installed in a float and a magnet installed in a strain-gauge unit.

The invention has been shown and described with reference to specific embodiments, which should be construed only as examples and do not limit the scope of practical applications of the invention. Therefore, any changes and modifications in technological processes, constructions, materials, shapes, and components are possible, provided these changes and modifications do not depart from the scope of the patent claims. For example, the liquid is not necessarily a winemaking must but may comprise a salt solution, juice, oil, petrochemical product, etc. The principle of the invention can be used for measuring the level of a liquid in a container or other characteristics that may be determined by measuring variations in electrical resistance of a strain gauge caused by displacement of a float. Guiding and/or magnetic repulsion can be done by electromagnets. The casing need not be hollow and can have positive or negative buoyancy. The strain gauge and housing may also be the float with the magnet fixed. The alignment can also be maintained by a highly flexible thin beam or any low friction coupling method. The strain gauge may be attached to the upper or to the lower surface of the elongated holder. In an embodiment where the floating casing is supported above the strain gauge casing by the flexible elements in a bridge manner, the strain gauge may be attached to the aforementioned flexible element instead of the beam which supports the magnet.

1. A method of measuring the density of a liquid comprising the steps of:
providing a sensor device that comprises a float unit with a first magnet and a strain-gauge unit with a second magnet;
immersing the float unit into the liquid the density of which is to be determined;
arranging the float unit and the strain-gauge unit at a distance that provides magnetic interaction between the first magnet and the second magnet; and
measuring the density variations in the liquid by registering deformations of the strain gauge caused by a force applied to the second magnet from the first magnet through the aforementioned magnetic interaction.

2. The method of claim 1, further comprising the step of arranging the first magnet and the second magnet so that their poles of identical polarity face each other for maintaining the first magnet and the second magnet in a state of equilibrium when the density of the liquid is constant.

3. The method of claim 2, further comprising the step of providing the float unit with a first sealed hollow casing, placing the first magnet into the first sealed hollow casing of the float unit, providing the strain-gauge unit with a second hollow casing, placing the strain gauge and the second magnet into the second hollow casing, and carrying out the aforementioned magnetic interaction through a space without physical contact between the first sealed hollow casing and the second hollow casing.

4. The method of claim 3, further providing the step of maintaining the first magnet and the second magnet in alignment by guiding the first sealed hollow casing along a vertical guide installed on the second hollow casing.

5. The method of claim 3, further providing the step of maintaining the first magnet and the second magnet in alignment by supporting the first sealed hollow casing above said second hollow casing by means of flexible elements that resist the aforementioned magnetic interaction between said first magnet and said second magnet.

6. The method of claim 4, wherein said second hollow casing is located above said liquid and wherein the vertical guide is directed downward from said second hollow casing towards said float unit.

7. The method of claim 1, wherein the liquid is a must used in a winemaking process, the density of which changes, depending on variation in percentage of sugar during fermentation of the must in the winemaking process.

8. The method of claim 7, further comprising the step of determining the percentage of sugar in a wine obtained from the must by using data obtained by the sensor in controlling the density of the must.

9. The method of claim 3, wherein the liquid is a must used in a winemaking process, the density of which changes, depending on variation in percentage of sugar during fermentation of the must in the winemaking process.

10. The method of claim 9, further comprising the step of determining the percentage of sugar in a wine obtained from the must by using data obtained by the sensor in controlling the density of the must.

11. The method of claim 3, further comprising the step of arranging the first magnet and the second magnet so that their poles of different polarity face each other and providing means that prevent the first sealed hollow casing and the second hollow casing from physical contact when variation in density of the liquid displaces the float unit toward the strain-gauge unit.

12. The method of claim 4, wherein the liquid is a must used in a winemaking process, the density of which changes, depending on variation in percentage of sugar during fermentation of the must in the winemaking process.

13. The method of claim 12, further comprising the step of determining the percentage of sugar in a wine obtained from the must by using data obtained by the sensor in controlling the density of the must.

14. A sensor for measuring density of a liquid comprising:
a float unit with a first magnet;
a strain-gauge unit with a second magnet;
the float unit and the strain-gauge unit being arranged at a distance that provides magnetic interaction between the first magnet and the second magnet, at least the float unit of said sensor being immersed into the liquid the density of which is to be determined.

15. The sensor of claim 14, wherein the first magnet and the second magnet have magnetic poles of identical polarity and magnetic poles of different polarity with respect to each other and wherein the first magnet and the second magnet are arranged so that their poles of identical polarity face each other.

16. The sensor of claim 15, wherein the float unit comprises a first sealed hollow casing that contains the first magnet, and wherein the strain-gauge unit comprises a second hollow casing that contains the strain gauge and the second magnet, said strain gauge having lead wires connected thereto and guided from the second hollow casing to the outside in a sealed manner.

17. The sensor of claim 16, further comprising an elongated member of a non-magnetic elastic material located inside the second hollow casing, one end of the elongated member being rigidly fixed to the second hollow casing and another end thereof supporting the second magnet.

18. The sensor of claim 17, further comprising alignment means for maintaining said first magnet and said second magnet in coaxial alignment.

19. The sensor of claim 18, wherein said alignment means comprises a rod installed on the second hollow casing for guiding the first sealed hollow casing in the vertical direction, the first magnet and the second magnet being arranged coaxially and maintained in coaxial positions by said guiding means.

20. The sensor of claim 19, wherein the guiding means comprises a through opening formed in the first casing and a rod attached to the second casing and wherein the casing is slidingly fitted on the rod without violating hermeticity of the first sealed hollow casing.

21. The sensor of claim 19, wherein the second hollow casing is located above said first sealed hollow casing and wherein the guiding means are directed downward from said second hollow casing towards said first sealed hollow casing so that said second hollow casing can be arranged above said liquid and said first sealed hollow casing can be immersed into said liquid.

22. The sensor of claim 21, wherein the guiding means comprises a through opening formed in the first casing and a rod attached to the second casing and wherein the casing is slidingly fitted on the rod without violating hermeticity of the first sealed hollow casing.

23. The sensor of claim 19, wherein said guide means comprises a tubular body in which said second hollow casing is slidingly fitted for free movement in the vertical direction.

24. The sensor of claim 23, wherein said second hollow casing has a spherical shape.

25. The sensor of claim 16, wherein the first sealed hollow casing is filled with a light filling material that is used for adjusting the weight of said float unit and for fixing the first magnet inside the first sealed hollow casing.

26. The sensor of claim 16, which is a sensor for determining the percentage of sugar in a winemaking must.

27. The sensor of claim 14, wherein the first magnet and the second magnet have magnetic poles of identical polarity and magnetic poles of different polarity with respect to each other and wherein the first magnet and the second magnet are arranged so that their poles of different polarity face each other, the sensor further comprising means that prevent the first sealed hollow casing and the second hollow casing from physical contact when variation in density of the liquid displaces the float unit toward the strain-gauge unit.

28. The sensor of claim 27, further comprising guiding means installed on the second hollow casing for guiding the first sealed hollow casing in the vertical direction, the first magnet and the second magnet being arranged coaxially and maintained in coaxial positions by said guiding means.

29. The sensor of claim 28, wherein the means that prevent the first sealed hollow casing and the second hollow casing from physical contact when variation in density of the liquid displaces the float unit toward the strain-gauge unit is a stopper formed on the guiding means.

30. The sensor of claim 18, wherein said alignment means comprise flexible means that support said first sealed hollow casing in a spaced position above said second hollow casing with said first magnet being in a coaxial alignment with said second magnet, said flexible means having flexibility that resists said magnetic interaction.
